(19) United States
(12) Patent Application Publication
(10) Pub. No.: US 2026/0222731 A1
(43) Pub. Date: Jul. 30, 2026

(54) MICROPHONE COMPRISING AN OUTER HOUSING

(71) Applicants: Widex A/S, Lynge (DK); SIVANTOS PTE. LTD., Singapore (SG)

(72) Inventors: Manuel WEISS, Lynge (DK); Hans BERNHARD, Lynge (DK); Kevin BAYER, Lynge (DK); Bernd MEISTER, Lynge (DK)

(73) Assignees: Widex A/S, Lynge (DK); SIVANTOS PTE. LTD., Singapore (SG)

(21) Appl. No.: 19/141,867

(22) PCT Filed: Dec. 19, 2023
(86) PCT No.: PCT/EP2023/086594

§ 371 Date: Jun. 20, 2025

(30) Foreign Application Priority Data
Dec. 23, 2022 (DK) PA 202201217

(51) Int. Cl. H04R 1/28; H04R 25/00

(52) U.S. Cl. CPC H04R 1/2884; H04R 25/604; H04R 2460/11

(57) ABSTRACT

The invention discloses a microphone (1), comprising an inner housing (4), said inner housing (4) comprising a port hole (2) through a first side wall (8) of the inner housing (4), said port hole (2) forming a sound inlet opening (36) of the microphone (1) or being fluidically connected to a sound inlet opening (36) of the microphone (1), a membrane (14) being disposed within the inner housing (4) and fluidically connected to the port hole (2), said membrane (14) separating the port hole (2) from an inner volume (12) enclosed by the inner housing (4), and an outer housing (6) at least partially enclosing, in an air-sealed way, a space which extends at least partially over at least one side wall (8, 10, 22, 24, 26) of said inner housing (4), thereby forming a first air chamber (28) between the outer housing (6) and the inner housing (4), wherein the inner housing (4) comprises an inner venting hole (30) fluidically connecting the inner volume (12) with the first air chamber (28).

The invention is related to a microphone, comprising an inner housing, said inner housing comprising a port hole through a first side wall of the inner housing, said port hole forming a sound inlet opening of the microphone or being fluidically connected to a sound inlet opening of the microphone, and said microphone further comprising a membrane being disposed within the inner housing and fluidically connected to the port hole, said membrane separating the port hole from an inner volume enclosed by the inner housing.

Hearing instruments are usually used to output a sound signal to the hearing of a wearer of the respective hearing instrument. This output sound signal is generated by means of an output transducer, usually acoustically via airborne sound by means of a loudspeaker (also referred to as “receiver”). Such hearing instruments are often used as so-called hearing aids. For this purpose, the hearing instruments normally comprise an acoustic input transducer (in particular a microphone) and a signal processor which is configured to process an input signal (also: microphone signal) generated by the input transducer from an ambient sound using at least one signal processing algorithm, usually stored in a user-specific manner, preferably in such a way that a hearing loss of the wearer of the hearing instrument is at least partially compensated. In particular in the case of a hearing aid, the output transducer can be, in addition to a loudspeaker, alternatively a so-called bone conduction receiver or a cochlear implant, which are set up for the mechanically or electrically stimulating the hearing of the wearer. Additional embodiments for an output transducer may be given by a middle ear implant or an ear lens. The term hearing instruments additionally includes in particular devices such as so-called tinnitus maskers, headsets, headphones and the like.

Typical designs of hearing instruments, in particular hearing aids, are behind-the-ear (“BTE”) and in-the-ear (“ITE”) hearing instruments. These terms refer to the intended wearing position. BTE hearing aids have a (main) housing which is worn behind the pinna and which encloses the input and output transducers, wherein a sound conduct transmits the sound generated by the output transducer towards the ear canal. A structurally similar design is the “Receiver-In-the-Canal” (RIC) hearing instrument in which the output transducer is disposed in an earbud. ITE hearing aids, on the other hand, have a housing that is worn in the pinna or even completely in the ear canal (so-called “CIC” design).

One common factor of these designs the lack of space for all electronic and electro-acoustic components. In particular, this holds for the microphones, which due to physical laws, need a certain amount of space for ensuring suitable acoustical properties such as a frequency response as flat as possible, and low noise. There exists a complex interplay between noise and resonance properties (which, in turn, also depend on the stiffness of the membrane and the like). A low noise generally may be achieved by a larger back volume “behind” the membrane (with respect to a microphone's sound inlet opening). However, in a hearing instrument as the ones given above, space for increasing the back volume is very limited.

It is therefore an object of the invention to provide a microphone that has a very compact design while still allowing for a low noise.

According to the invention, the object is achieved by a microphone, comprising an inner housing, said inner housing comprising a port hole through a first side wall of the inner housing, said port hole forming a sound inlet opening of the microphone or being fluidically connected to a sound inlet opening of the microphone, a membrane being disposed within the inner housing and fluidically connected to the port hole, said membrane separating the port hole from an inner volume enclosed by the inner housing, and an outer housing at least partially enclosing, in an air-sealed way, a space which extends at least partially over at least one side wall of said inner housing in an air-sealed way, thereby forming a first air chamber between the outer housing and the inner housing, and wherein the inner housing comprises an inner venting hole fluidically connecting the inner volume with the first air chamber. Embodiments of particular advantage, which may be inventive in their own right, are outlined in the depending claims and in the following description.

The design of the microphone then can be outlined as follows: The inner housing of the microphone encloses an inner volume. Inside said inner housing, the membrane of the microphone is disposed. A port hole penetrates through a first side wall of the inner housing, permitting sound to propagate through the port hole towards the membrane inside the inner housing. Preferably, the membrane is disposed close to the port hole (in relation to the total extension of the inner housing), and, most preferably, spanned in parallel to the first side wall. The membrane is fluidically connected to the port hole, i.e., sound propagating through the port hole can propagate to the membrane.

The inner volume enclosed by the inner housing is defined as the part of the volume enclosed by the inner housing which is separated from the port hole by the membrane.

Then, the microphone furthermore comprises an outer housing which at least partially encloses, i.e., surrounds a space that extends at least partially over at least one side wall of the inner housing in a way such that a first air chamber is formed between the side walls of the inner housing and the side walls of the outer housing where the outer housing covers the inner housing. Thus, the respective side walls of the outer housing which also enclose the first air chamber, are joint to the side walls of the inner housing in an air-sealed way, such that the first air chamber is encapsuled by the outer housing without any fluidic connection to the exterior other than via the inner volume and the port hole. The first air chamber, however, has a fluidic connection to the inner volume enclosed by the inner housing via the inner venting hole.

The outer housing thus extends at least partially over one side wall, and preferably, extends at least partially over two different side walls of the inner housing, most preferably in a way such that the first air chamber also extends at least partially over the respective side wall(s) of the inner housing. The inner housing preferably has a geometrically regular shape, such as a rectangular or cylindrical box with possibly rounded edges at its side walls (or possibly wedge-shaped joints of several side walls), i.e., the inner housing preferably has two opposite basis side walls with a geometrically regular footprint such as a rectangle or a circle or an ellipse, and lateral side walls joining the basis side walls together. At least one of the basis side walls typically may be planar, as this facilitates mounting the microphone on a carrier or a circuit board (in particular, if the basis side wall is also a side wall of the microphone itself). The opposite basis side wall may have some curvature but can also be planar (this may help to provide for an easier production).

In general, the height of such a box-shaped microphone may be given by the extension perpendicular to said basis side wall. Normally, providing a microphone with an inner housing enclosing a larger inner volume for improving the noise properties will increase this height, leading to a larger microphone component with a lower mechanical size efficiency.

The invention solves this problem by introducing a back volume—embodied in the first air chamber—which extends at least partially over one side wall, and preferably at least partially over least two of the side walls of the inner housing, i.e., the back volume can be “wrapped around” parts of the inner housing, starting from the inner housing's side wall where the inner venting hole to the first air chamber, i.e., to the back volume is disposed.

The basis side wall as described above is preferably given by the first side wall. Then, in case of a rectangular box-shaped inner housing, the outer housing may be “wrapped” around the inner housing in a way that the side wall opposite to the first side wall (i.e., the “other” basis side wall), and possibly, at least one lateral side wall, preferably two lateral side walls, and most preferably the four lateral side walls, are covered at least partially by the outer housing, i.e., the outer housing extends over said side walls at least in part. This way, the back volume given by the first air chamber may be designed in a way that the available space for the microphone is optimized. Normally, a microphone configured for a use in a hearing instrument such as a hearing aid, comprises a small basis plate at the basis side wall, said basis plate exceeding the footprint of the lateral side walls and being typically given by a circuit board. So, the space necessary for mounting the microphone in the hearing aid is essentially determined by said basis plate. The outer housing then just takes advantage of this excess free space (i.e., the free space from the basis plate beyond the inner housing) provided by the basis plate.

Preferably, the inner housing (and possibly, the outer housing, as well) is manufactured from a suitable rigid material, such as a metal, an alloy, a plastic material or a composite material. For the case of metal and/or alloy, the respective contact lines of the side walls of the outer and the inner housing, may comprise or entirely be given by solder joints. However, the outer housing may also be plastic molded, and/or plug-connected into a pre-milled nut of the inner housing (in particular for the case of a plastic or composite material).

In case that the first side wall is also a side wall of the full microphone, the port hole through the first side wall is also a sound inlet opening of the microphone. In the case that the outer housing also surrounds the first side wall (e.g., in an embodiment in which the outer housing fully surrounds the inner housing or in an embodiment in which the inner and the outer housing only share two common, opposing lateral side walls), such a sound inlet opening of the microphone in the outer housing is fluidically connected with the port hole.

The outer housing forming the first air chamber may have any possible shape, i.e., regular or irregular, convex or non-convex, and may be either given by a dedicated housing component of the microphone, or may be given at least partially by a component of the surrounding device which may be given by a hearing instrument. In this case, at least a portion of the outer housing may be given by a part of the housing and/or by a part of some sealing of the hearing instrument.

In particular, the inner housing and the outer housing may form a non-convex assembly. This might be useful when fitting the full microphone into a hearing instrument with limited space or a similar device.

In such an embodiment, the first air chamber, with respect to the inner volume, preferably extends at least partially beyond a basis plane of the microphone defined by a first side wall of the inner housing, said first side wall preferably comprising the port hole. This means in particular that the first air chamber, and thus, the outer housing protrudes over the basis plane.

In particular, the inner venting hole may then also be disposed in the first side wall, and the inner volume and the first air chamber are thus disposed on opposite sides of the first side wall. Such an assembly is particularly efficient for manufacturing, as it requires only two capsule-like structures to be mounted onto opposite sides of a basis plate forming the first side wall. The inner volume is formed in the enclosure of one of these structures, and the first air chamber is formed in the enclosure of the other structure.

In an embodiment, the first side wall is given by a circuit board, in particular by a printed circuit board (PCB). Then, electronic components of the microphone such as a pre-amplifier for the analog signal generated by means of the membrane may be included in the microphone.

in an embodiment, the first side wall of the inner housing defines the basis plane of the microphone, wherein the outer housing extends from at least partially enclosing a second side wall of the inner housing, said second side wall being opposite to the first side wall (i.e., the inner volume is enclosed between the first and the second side wall), the outer housing preferably extending at least to said basis plane. This means in particular that the outer housing covers the second side wall which is the side wall opposite or even parallel to the first side wall (with respect to the interior of the inner housing), and then extends over the edges of said second side wall to at least some of the adjacent lateral side walls that join the second side wall to the first side wall. Preferably, the outer housing then does no stretch over the basis plane, and in particular does not form any sort of bulge below the first side wall.

In this embodiment, the inner venting hole is preferably disposed in said second side wall of the inner housing, i.e., on the side wall opposite (or even parallel) to the first side wall. In general, the inner venting hole may also be disposed in one of the lateral side walls.

In particular, in this case the outer housing may enclose the second side wall, preferably over its entire length, and at least partially encloses a first and second lateral side wall, said first and second lateral side wall being opposite or even parallel to each other and mechanically connecting the first side wall with the second side wall. In other words, in a cross-sectional view, the inner housing comprises the first and second side wall opposed (or even parallel) to each other, and the first and second lateral side walls opposed (or even parallel) to each other, wherein each of the first and second lateral side wall is joint to the first and to the second side wall at one edge. Preferably, the cross-section is then essentially rectangular.

In an embodiment, the port hole is forming the sound inlet opening of the microphone. In particular, this means that the first side wall is also a side wall of the microphone. In this case, the outer housing preferably extends at most to the basis plane, i.e., the outer housing does not exceed over the first side wall by some sort of a bulge, but the microphone has is planar at the first side wall, such that it may easily be mounted on a PCB or the like.

In an alternative embodiment, said outer housing comprises the sound inlet opening of the microphone, wherein said outer housing at least partially extends over said first side wall of the inner housing, thereby forming a second air chamber, the second air chamber being air-sealed from the first air chamber, and fluidically connecting said sound inlet opening in the outer housing with the port hole in the first side wall of the inner housing, thereby forming a sound transmission channel from the port hole to the sound inlet opening. This means in particular that the outer housing is also “wrapped” (at least partially) around the first side wall, at least up to the port hole, which therefore is no longer acting as the sound inlet opening of the microphone. Instead, the second air chamber formed between the outer housing and the inner housing, and air-sealed from the first air chamber acting as the back volume, forms a sound transmission channel from the sound inlet opening—which is now penetrating the outer housing towards the second air chamber—to the port hole. The second air chamber may be given by the entire space between the outer and the inner housing up to some separation walls separating the first and second air chamber, or by a dedicated sound guide formed by additional side walls in said space.

In this embodiment, preferably, the membrane defines a membrane plane, wherein the sound inlet opening is disposed in the outer housing in a way such that the sound transmission channel intersects the membrane plane, the sound transmission channel thus being divided in a port-side part and a rear-side part that is located within a rear-side region of the membrane plane with regards to the port hole. This means in particular that the sound transmission channel leads which leads from the port hole to the sound inlet opening of the outer housing, is divided by the membrane plane into the port-side part by the port hole, and the rear-side part on the opposite side of the membrane plane with respect to the port hole. Thus, the rear-side part of the sound transmission channel leads from the sound inlet opening to the membrane plane. This allows for a design in which the port hole is disposed away from the sound inlet opening, with respect to the inner housing, so that air in the sound transmission channel may compensate for movements of the membrane due to unwanted vibrations.

Preferably, in this case, an air column within the rear-side part of the sound transmission channel has parts that are perpendicular to the membrane plane, wherein an effective length of the rear-side part of the sound transmission channel is chosen in dependence on an acoustic inertia of the microphone and in particular of the membrane, said effective length being defined as the vectorial portion of the rear-side part of the sound transmission channel that is perpendicular to the membrane plane. In particular, this means that the effective length of the rear-side part of the sound transmission channel, which may be given by the distance of the sound inlet opening to the membrane plane, may be chosen such that during unwanted vibrations or movements of the microphone, the additional air pressure on the membrane arising from the movement of the air column in the rear-side part compensates for the inertia of the membrane.

In an embodiment, the inner housing has the shape of an essentially rectangular box, possibly with rounded edges and/or wedge-shaped joints, wherein the outer housing has the shape of an essentially rectangular box, possibly with rounded edges and/or wedge-shaped joints, the outer housing fully surrounding the inner housing up to possible common side walls. A rectangular box-shape for the microphone is particularly useful for mounting the microphone in a hearing instrument. By fully surrounding the inner housing with the outer housing—up to common side walls—i.e., by fully surrounding the inn housing with the first (and possibly second) air chamber, a very compact design is possible.

In an embodiment the volume of the first air chamber is chosen in dependence on the inner volume and/or the total volume enclosed by the inner housing. The inner volume is given by the portion of the total volume enclosed by the inner housing which is separated from the port hole by the membrane. The first air chamber can act as a back volume for the inner volume more efficiently if its volume is adjusted to the inner volume, which in turn also depends on said total volume enclosed by the inner housing.

In an embodiment, an acoustic filter is disposed in the first air chamber. Preferably said acoustic filter is designed and configured to obtain a flat frequency response and/or to match the inner volume to the volume of the first air chamber.

The invention further comprises a hearing instrument with a microphone as described above. The hearing system according to the invention shares the advantages of the method for operating a hearing system according to the invention. Particular assets of the method and of its embodiments may be transferred, in an analogous way, to the hearing system and its embodiments, and vice versa.

The attributes and properties as well as the advantages of the invention which have been described above are now illustrated with help of drawings of embodiment examples. In detail,

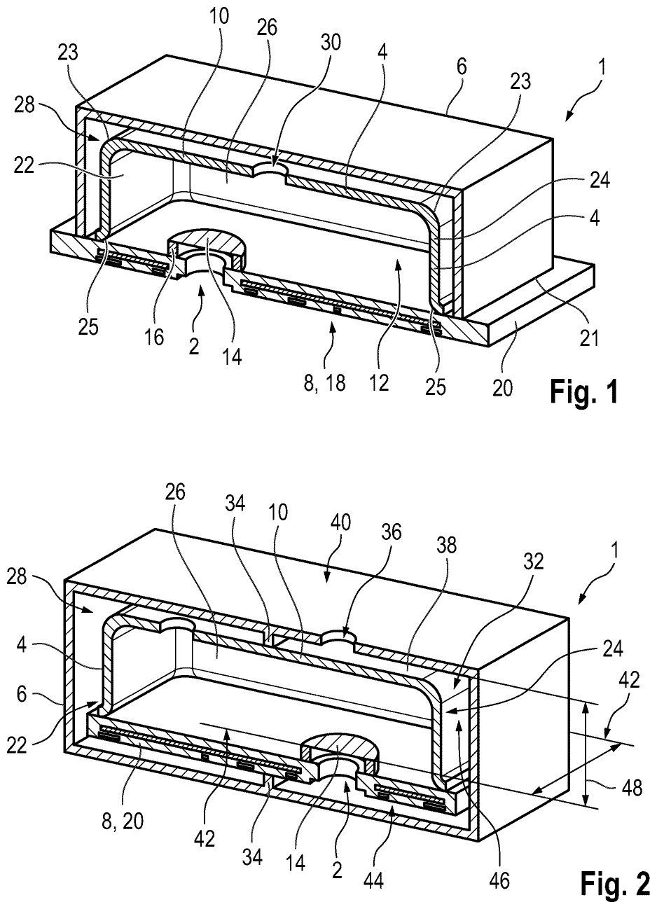

FIG. 1 is showing a cross-sectional view of a microphone comprising an outer housing surrounding an inner housing, thereby forming a back volume,

FIG. 2 is showing a cross-sectional view of an alternative to the microphone of FIG. 1, containing also a sound transmission channel inside the outer housing,

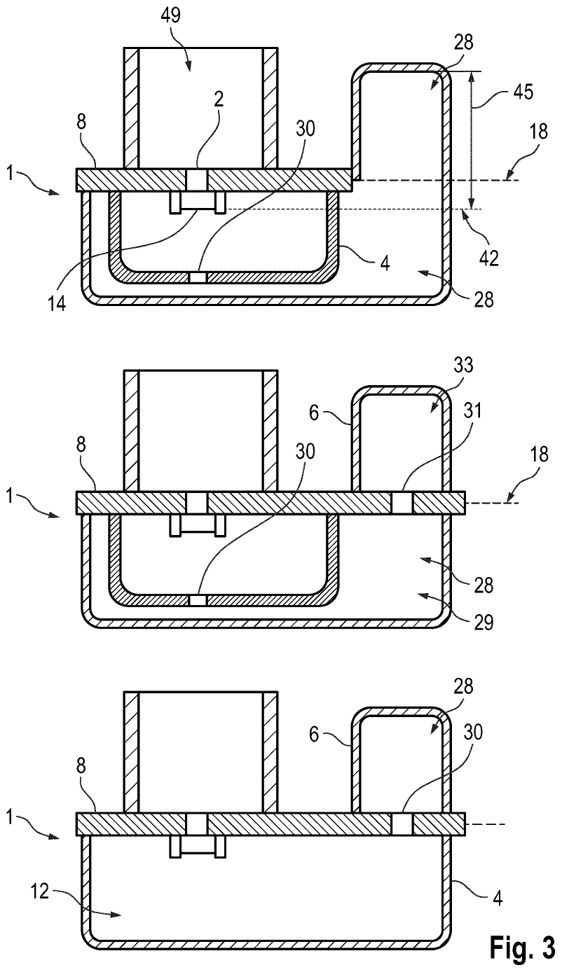

FIG. 3 is showing a cross-sectional view of yet another alternative to the microphone of FIG. 1 in three different embodiments, extending the back volume beyond the plane of the port hole, and

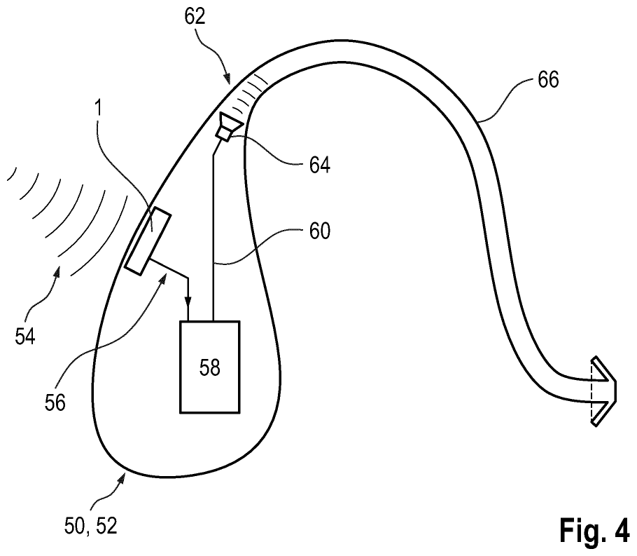

FIG. 4 is showing a schematic block diagram of a hearing instrument with a microphone according to FIG. 1, FIG. 2.

Parts and variables corresponding to one another are provided with the same reference numerals in each case of occurrence for all figures.

In FIG. 1, a schematic cross-sectional view of a microphone 1 is shown in perspective representation. The microphone 1 is particularly configured for being disposed and used in a hearing instrument, such as a hearing aid (not shown). In particular, the microphone 1 in this use case shall be disposed within the hearing aid in a way such that sound (i.e., periodic changes of the air pressure propagating through the air) entering the hearing aid through a sound inlet opening shall propagate at least partially around the microphone 1 in order to enter the interior of the microphone 1 through a port hole 2, wherein electro-acoustic components of the microphone are disposed in said interior.

The microphone 1 comprises an inner housing 4 and an outer housing 6, said outer housing 6 enclosing the inner housing 4 at least partially. In the present case, the inner housing comprises a first side wall 8, and a second side wall 10 being opposite to the first side wall 8, i.e., the first side wall 8 and the second side wall 10 are disposed opposed to each other with respect of an inner volume 12 of the inner housing 4. Inside said inner volume 12, a membrane 14 is disposed on a socket 16 close to and covering the porthole 2, said membrane 14 being parallel to a basis plane 18 that is defined by the first side wall 8. The membrane 14 forms part of the electro-acoustic components of the microphone 1, which are not shown in any further detail in FIG. 1, and which may further comprise wirings and/or other types of electronic connections. In the present case, the first side wall 8 is given by a circuit board 20, which in particular may be given by a printed circuit board, and which, in particular may be connected electronically to the membrane 14 and/or further electro-acoustic components and/or electronic components (not shown) inside the interior 12 of the inner housing 4.

In the embodiment shown in FIG. 1, both the inner housing 4 and the outer housing 6 have the shape of a rectangular box, the outer housing 6 fully enclosing the inner housing 4, except for the common side wall given by the first side wall 8 of the inner housing 4. The circuit board 20 forming said first side wall 8 slightly extends beyond the contour 21 of the outer housing 6 on the circuit board 20. At this portion of the circuit board 20, no surrounding or enclosure of the inner housing 4 by the outer housing 6 occurs, so it is only a semantical question whether to count the part of the circuit board 20 beyond the outer housing's contour 21 to the outer housing 6 or to the inner housing 4, or to both (as a common part or portion); for practical purposes, this question does not need to be addressed.

The inner housing 4 further comprises a first lateral side wall 22 and a second lateral side wall 24, said first lateral side wall 22 and second lateral side wall 22 being opposed to each other with respect to the inner volume 12, and each connecting the first side wall 8 and the second side wall 10. In the present embodiment, the first and second lateral side wall 22, 24 are parallel to each other, except for rounded edges 23 towards the second side wall 10 and wedge-shaped joints 25 to the first side wall 8. The rectangular shape of the inner housing 4 is completed by a rear side wall 26, and another side wall opposed to the rear side wall 26 and not shown in FIG. 1, due to the cross-sectional representation.

Between the inner housing 4 and the outer housing 6, a first air chamber 28 is formed, said first and chamber 28 being fluidically connected to the inner volume 12 via an inner venting hole 30.

The first air chamber 28 is designed and configured to act as a so-called back volume of the microphone 1. A back volume typically is added to a microphone with an inner volume, in particular in the case of box-shaped, housing-cased microphones, in order to improve the noise floor of the microphone. Furthermore, acoustic filters for additionally smoothing the frequency response and/or filtering ultra-sonic resonances or other undesired phenomena may be disposed in such a back volume.

Typically, the back volume increases the overall height or thickness of a cased microphone, as the back volume is added on top of the main volume. The microphone 1 shown in FIG. 1 is particularly designed and configured to be mounted inside a hearing aid with the porthole 2 pointing away from the hearing aid's housing, that means, the sound impinging on the hearing aid where the microphone 1 is mounted inside, penetrates through some sound inlet opening of the hearing aid's housing, and is then guided through some sound transmission channel (not shown in FIG. 1) around the outer housing 6 towards the porthole 2. So, in particular for this sort of construction and design, the distribution of the back volume “around” the inner housing 4, i.e., by means of the first air chamber 28 enclosing (at least partially) the inner housing 4, the overall height of the microphone 1 can be kept sufficiently small for its desired application as mentioned above.

Even though in the embodiment shown in FIG. 1, the outer housing 6 fully encloses the inner housing 4, i.e., the first sound chamber 28 fully surrounds the inner housing 4 (except for its first side wall 8 given by the circuit board 20), other designs are possible. For example, the first sound chamber 28 laterally might surround the inner housing 4 only at the first and second lateral side wall 22, 24, whereas the inner and the outer housing 4, 6 may share a common side wall at the position of the rear side wall 26 of the embodiment shown in FIG. 1. Furthermore, layouts with a non-rectangular projection onto the circuit board 20 (e.g., with a circular projection) are thinkable. Finally, the outer housing 6 might not fully extend over the lateral side walls of the inner housing 4 (i.e., the first lateral, second lateral and rear side wall 22, 24, 26 of FIG. 1), but also could be joined to said sidewalls, instead of being joined to the circuit board 20, as shown in FIG. 1. In the latter case, the sidewalls might not be perpendicular to the circuit board 20, but preferably are skewed towards the inner volume 12. The inner venting hole 30 might also be disposed in one of the lateral side walls 22, 24 (not shown).

In FIG. 2, a schematic cross-sectional view of an alternative to the microphone of FIG. 1 is shown. The microphone 1 shown in FIG. 2 has an outer housing 6, which now fully surrounds the inner housing 4, at least at two opposing lateral side walls (which in this case are given by the first and second lateral side wall 22, 24). The rear side wall 26 (and the remaining side wall opposed to the rear side wall 26 that is not shown in FIG. 2 due to the cross-sectional representation) may also be sur-rounded by the outer housing 6, i.e., the first air chamber 28 may at least partially extend over said rear side wall 26. The rear side wall 26 (and possibly, also the corresponding opposite side wall) may also form common side walls of the inner and the outer housing 4, 6.

Similar to the embodiment shown in FIG. 1, the first side wall 8 of the inner housing 4 is formed by a circuit board 20, and a porthole 2 penetrates said first side wall 8, the membrane 14 being disposed close to the porthole 2 in the inner volume 12 enclosed by the inner housing 4.

Now, however, in addition to the first air chamber 28 between the outer housing 6 and the inner housing 4, a second air chamber 32 is formed between the outer and the inner housing 6, 4, said second air chamber 32 being air-sealed from the first air chamber 28 by separation walls 34 which connect the outer housing 6 to the inner housing 4 in an air-sealed way. As shown in the embodiment of FIG. 1, the first air chamber 28 is fluidically connected to the inner volume 12 inside the inner housing 4 via the inner venting hole 30. Said inner venting whole 30 is disposed in the second side wall 10 in a way such that a plane (not indicated) spanned by the separation walls 34 also separates the port hole 2 and the inner venting hole 30, i.e., these two holes lie on opposite sides of such a plane. The separation walls 34 may be formed as inwards-pointing parts of the outer housing 6, or as parts protruding the inner housing 4 at the second side wall 10 and protruding the circuit board 20. The inner venting hole 30 might also be disposed in the first lateral side wall 22, or in the first side wall 8, beyond the separation wall 34 (with respect to the port hole 2).

Furthermore, a sound inlet opening 36 penetrates the outer housing 6 at a side wall that is covering the second side wall 10 of the inner housing 4, and at a position being on the same side of the above-mentioned plane spanned by the separation walls 34 as the port hole 2. On this side of said plane, the second air chamber 32 is formed between the outer housing 6 and the inner housing 4, wherein a sound transmission channel 38 is formed from the sound inlet opening 36 to the port hole 2.

The first air chamber 28 acts as a back volume, in an analogous way as shown in FIG. 1. The sound transmission channel 38 formed at least in and preferably by the second air chamber 32, may help guiding sound impinging on the upper side 40 of the microphone 1 (even when said microphone 1 is encapsulated in a hearing aid with a hearing aid's sound inlet opening aligned with the sound inlet opening 36 of the microphone 1) around the inner housing 4 to enter the port hole 2 at the opposite side.

The sound transmission channel 38 is divided by a membrane plane 42, said membrane plane 42 simply being the plane defined by the membrane 14 (and extended beyond the membrane 14 in all directions), into a port-side part 44 and a rear-side part 46 Then, the port-side part leads from the membrane plane 42 to the porthole 2, and the rear-side part 46 leads from the membrane plane 42 to the sound inlet opening 36. For the rear-side part 46, and effective length 48 can be defined as the length of all the vectorial components of the rear-side part in the sound transmission channel 38 that are perpendicular to the membrane plane (in the example shown in FIG. 2, the effective length 48 is given by the distance of the sound inlet opening 38 to the membrane plane 42).

By properly adjusting said effective length 48, the air column in the rear-side part may compensate the acoustic inertia of the membrane 14 during movements of the microphone 1 that have a vectorial component perpendicular to the membrane plane 42. In this case, the forces on the membrane 14 due to gravitation and/or inertia may be cancelled out by opposite forces on the air of the rear-side part of the sound transmission channel 38, for a proper choice of the effective length 48 of the rear-side part 46.

In FIG. 3, a schematic cross-sectional view of another alternative to the microphone of FIG. 1 is shown in three different embodiments. The top embodiment is showing a microphone 1, in which the outer housing 6 surrounds the inner housing 4 up to the first side wall 8, but then extends beyond the basis plane 18 (dashed line) defined by the first side wall, leading to a non-convex assembly of the outer housing 6 and the inner housing 4 (at the common side wall formed by the first side wall 8). Thus, the first air chamber 28 also extends beyond the basis plane 18, and in particular, beyond the membrane plane 42 (dotted line). This extension of the first air chamber 28 beyond the basis plane may help to reduce vibration feedback due to the higher air column 45 perpendicular to the membrane plane 42. The microphone 1 further comprises a front volume 49, disposed at the port hole 2 on the opposite side of the first side wall 8 (with respect to the membrane 14, and fluidically connecting the port hole 2 to a sound inlet opening (not shown).

The embodiment of the microphone 1 in the middle of FIG. 3 is a variation of the first embodiment of FIG. 3 described above. However, now the first side wall 8 intersects the first air chamber 28 protruding beyond the basis plane 18. The first air chamber 28, this way, comprises two portions: one first portion 29 extending from the inner venting hole 30 to an auxiliary venting hole 31 disposed in the lateral extension of the first side wall 8, and a second portion 33 beyond the first side wall 8. The outer housing 6 that seals the second portion 33 of the first air chamber 28 may be given by some housing and/or sealing component of a hearing instrument (not shown) that holds the microphone 1.

The embodiment of the microphone 1 shown in FIG. 3, bottom, takes the auxiliary venting hole 31 of the middle embodiment as its inner venting hole 30. Thus, the first air chamber 28 is disposed entirely on the opposite side of the first side wall 8, with respect to the inner volume 12, i.e., the outer housing 6 and the inner housing 4 are disposed on opposite sides of the first side wall 8, which they share as a common side wall in the surroundings of the inner venting hole 30. Note that in this embodiment, the first air chamber 28 consists only of the second portion 33 first air chamber 28 as given by the embodiment shown in the middle of FIG. 3.

FIG. 4 is showing a schematic block diagram of a hearing instrument 50 which is given by a hearing aid 52. The hearing aid 52 comprises at least one microphone 1 given by any of the embodiments shown in FIG. 1 and FIG. 2, which is set up and configured to convert an ambient sound 54 into an input signal 56. The hearing aid 52 may also comprise a second microphone (not displayed in FIG. 3) given by any of the embodiments shown in FIG. 1 and FIG. 2. Said input signal is 56 is processed by a signal processing unit 58 into an output signal 60, which in turn is converted into an output sound 62 by an electro-acoustic output transducer 64 such as, e.g., a speaker or a receiver, and led through a sound conduct 66 towards a hearing of a wearer (not shown). The hearing aid 52 is given as a BTE design, but may equally be given by an ITE, CIC, or RIC design. However, the hearing instrument 50 might also be given by a bone conduction device, or a so-called IIC device or as an integration into a RIC unit, or by a TWS earbud, or the like.

Even though the invention has been illustrated and described in detail with help of a preferred embodiment example, the invention is not restricted by this example. Other variations can be derived by a person skilled in the art without leaving the extent of protection of this invention.

### REFERENCE NUMERAL

1 microphone
2 port hole
4 inner housing
6 outer housing
8 first side wall
10 second side wall
12 inner volume (of the inner housing)
14 membrane
16 socket
18 basis plane
20 circuit board
21 contour (of the outer housing)
22 first lateral side wall
23 rounded edge
24 second lateral side wall
25 (wedge-shaped) joint
26 rear side wall
28 first air chamber
29 first portion (of the first air chamber)
30 inner venting hole
31 auxiliary venting hole
32 second air chamber
33 second portion (of the first air chamber)
34 separation wall
36 sound inlet opening
38 sound transmission channel
40 upper side (of the microphone)
42 membrane plane
44 port-side part
45 air column
46 rear-side part
48 effective length
49 front volume
50 hearing instrument
52 hearing aid
54 ambient sound
56 input signal
58 signal processing unit
60 output signal
62 output sound
64 output transducer
66 sound conduct

1. A microphone comprising
an inner housing, said inner housing comprising a port hole through a first side wall of the inner housing, said port hole forming a sound inlet opening of the microphone or being fluidically connected to a sound inlet opening of the microphone,
a membrane being disposed within the inner housing and fluidically connected to the port hole said membrane separating the port hole from an inner volume enclosed by the inner housing, and
an outer housing at least partially enclosing, in an air-sealed way, a space which extends at least partially over at least one side wall of said inner housing, thereby forming a first air chamber between the outer housing and the inner housing, and
wherein the inner housing comprises an inner venting hole fluidically connecting the inner volume with the first air chamber.

2. The microphone according to claim 1,
wherein said outer housing extends at least partially over at least two different side walls of the inner housing.

3. The microphone according to claim 1,
wherein said outer housing extends, at least partially, at most over one side wall of said inner housing.

4. The microphone according to claim 1,
wherein the inner housing and the outer housing form a non-convex assembly.

5. The microphone according to claim 4,
wherein the first air chamber with respect to the inner volume extends at least partially beyond a basis plane of the microphone defined by a first side wall of the inner housing, said first side wall comprising the port hole.

6. The microphone according to claim 5 wherein said outer housing extends, at least partially, at most over one side wall of said inner housing, and
wherein the inner venting hole is disposed in the first side wall, and the inner volume and the first air chamber are disposed on opposite sides of the first side wall.

7. The microphone according to claim 1,
wherein the outer housing extends at most to the basis plane of the microphone defined by the first side wall.

8. The microphone according to claim 1,
wherein the outer housing extends from at least partially enclosing a second side wall of the inner housing, said second side wall being opposite to the first side wall, the outer housing preferably extending at least to said basis plane.

9. The microphone according to claim 8,
wherein the outer housing encloses the second side wall, preferably over its entire length, and at least partially encloses a first and second lateral side wall, said first and second lateral side wall being opposite to each other and mechanically connecting the first side wall with the second side wall.

10. The microphone according to claim 1,
wherein said outer housing comprises the sound inlet opening of the microphone and
wherein said outer housing at least partially extends over said first side wall of the inner housing, thereby forming a second air chamber the second air chamber being air-sealed from the first air chamber, and fluidically connecting said sound inlet opening in the outer housing with the port hole in the first side wall of the inner housing, thereby forming or at least enclosing a sound transmission channel from the port hole to the sound inlet opening.

11. The microphone according to claim 10,
wherein the membrane defines a membrane plane
wherein the sound inlet opening is disposed in the outer housing in a way such that the sound transmission channel intersects the membrane plane the sound transmission channel thus being divided in a port-side part and a rear-side part that is located within a rear-side region of the membrane plane with regards to the port hole.

12. The microphone according to claim 11,
wherein an air column within the rear-side part of the sound transmission channel has parts that are perpendicular to the membrane plane and
wherein an effective length of the rear-side part of the sound transmission channel is chosen in dependence on an acoustic inertia of the microphone and in particular of the membrane, said effective length being defined as the vectorial portion of the rear-side part of the sound transmission channel that is perpendicular to the membrane plane.

13. The microphone according to claim 1, wherein the port hole is forming the sound inlet opening of the microphone.

14. The microphone according to claim 1,
wherein the inner housing has the shape of an essentially rectangular box, and
wherein the outer housing has the shape of an essentially rectangular box, the outer housing fully surrounding the inner housing up to possible common side walls.

15. The microphone according to claim 1,
wherein the first side wall is given by a circuit board.

16. The microphone according to claim 1,
wherein an acoustic filter is disposed in the first air chamber.

17. A hearing instrument comprising a microphone according to claim 1.

18. The hearing instrument according to claim 17,
wherein at least a portion of the outer housing is formed by at least one part of the hearing instrument.

19. The hearing instrument according to claim 18,
wherein said at least one part of the hearing instrument is given by
a housing of the hearing instrument, and/or
an inner frame of the hearing instrument and/or
a rubber sealing of the hearing instrument and/or
a microphone suspension of the hearing instrument.
